(19) United States
(12) Patent Application Publication
(10) Pub. No.: US 2008/0017183 A1
(43) Pub. Date: Jan. 24, 2008

(54) BRICK-OVEN HAVING A SMOKE AND ODOR REMOVING FILTER

(75) Inventor: Saburo AONUMA, Shinagawa-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sataco Co., Ltd., Shinagawa-ku (JP)

(21) Appl. No.: 11/739,164

(22) Filed: Apr. 24, 2007

(30) Foreign Application Priority Data
Jul. 21, 2006 (JP) 2006-222760

(51) Int. Cl. A21B 1/00

(52) U.S. Cl. 126/21 R

(57) ABSTRACT

A brick-oven includes a reduced emission of smoke and odor generated from the brick-oven. A brick-oven includes a catalyst layer in a smoke and odor removing filter in a tubular smoke exhaust section. In one example, a heater is provided in the vicinity of the catalyst layer of the catalyst treatment section of the smoke and odor removing filter.

This application is based on the priority document of Japanese Patent Application No. 2006-222760 filed on Jul. 21, 2006, and claims the benefits of priority thereof. The entire contents of the priority document are incorporated herein referring to the priority document.

### BACKGROUND OF THE INVENTION

This invention relates to a brick-oven or rock-oven having a smoke and odor removing filter therein.

In shops and restaurants, sometimes, a brick-oven is used for baking pizza crust, bread dough, and biscuit dough etc. FIG. 11 is a sectional view showing a conventional brick-oven as an example of such brick-oven. In this figure, structure of the conventional brick-oven is made of an oven body 91, and a smoke exhaust section 92. The oven body 91 has an opening section 93 for putting in or taking out pizzas etc., an oven-bed 95 for placing a metal tray having pizza crusts therein, and an oven-wood burning place 94 behind the tray. When oven-wood is burnt, inside the brick-oven is heated to a temperature high enough for baking the piazza crusts while smoke and odor are generated. These smoke and odor are led toward a smoke exhaust outlet section 97 through a smoke intake throat 96 provided above the opening section 93, and further through a tubular duct section 98, and then they are released into an open air.

Conventionally, the tubular duct section 98, a blower fan 99 is sometimes provided to take in air for accelerating smoke exhaust. In addition, an aqua-filter is sometimes provided for removing smoke and odor.

In order to dispose smoke and odor generated from the brick-oven, such disposal involves many problems including designing of the oven such as density of elements in smoke and amount of disposal flow rate, and other factors such as operating conditions including temperature setting for baking dough and processing time, operation and maintenance conditions.

Conventionally, the use of catalyst action is known for oxidative decomposition of smoke and deodorization. For an efficient deodorization, elements such as catalyst type, applying condition, structure, and a supported material or a supported metal catalyst is considered as important factors. As a condition for using a catalyst, it is important to keep the catalyst at a high temperature, and requirements for selecting structure and material, little resistance in smoke flow path is required while a large contacting surface area in contact with smoke and odor gas is required.

As a prior art, Japanese Patent Publication H08-35674 describes a smoke removing and deodorizing device of cooking system having a high resistance against thermal shock and an easy maintenance by a method provided one or more supporting rods having a ceramic member carrying catalyst for promoting decomposition of odor or smoke and a supporting frame for supporting both ends of the supporting rods.

### SUMMARY OF THE INVENTION

In the conventional smoke and odor removing method, only smoke can be removed before releasing it into ambient, but odor included in the releasing smoke cannot be sufficiently reduced. In recent years, breads and pizzas are baked in shops and restaurants; accordingly, the number of brick-ovens is increased. In addition, as living areas and shopping areas become closer, such brick-ovens are requested for the maintenance of better living environment for neighboring areas so that smoke and odor generated therefrom is requested for reduction substantially.

It is an object of the present invention to reduce smoke and odor generated from the brick-oven, and in particular, the brick-oven is characterized by having a smoke and odor removing filter.

According to claim 1 of the present invention, a brick-oven has an oven body, a smoke and odor removing filter, wherein the smoke and odor removing filter includes a catalyst member at a smoke exhaust section.

According to claim 2 of the present invention, a brick-oven as defined by claim 1, further includes a heater in the vicinity of the catalyst member of the smoke and odor removing filter.

According to claim 3 of the present invention, a brick-oven as defined by any one of claim 1 or 2, wherein at least the smoke and odor removing filter is installed at a throat of the smoke exhaust section of the brick-oven, or in the smoke exhaust stack section.

According to claim 4 of the present invention, a brick-oven as defined by any one of claims 1 through 3, further including:

an air intake blower fan or an exhaust blower fan are provided in the smoke exhaust stack section.

According to claim 5 of the present invention, a brick-oven as defined by any one of claims 1 through 4, further including:

the smoke and odor removing filter having the catalyst member, a heating plate, and the heater as constituents thereof.

According to claim 6 of the present invention, a brick-oven as defined by any one of claims 1 through 4, further including:

a plurality of the smoke and odor removing filters at a plurality of stages.

According to the brick-oven having the smoke and odor removing filter, the brick-oven includes the structure of a brick-oven body and a smoke exhaust section. The brick-oven body has a place for baking breads, pizzas and biscuit etc. and a place for burning oven-wood. Dough of breads, pizzas and biscuits are placed in a metal tray or a tray made of a heat-resisting material and stored in the brick-oven. In the brick-oven body, the section for burning fuel or firewood is provided in the vicinity of a location where the dough is placed. In the brick-oven body, an opening section is provided for placing the dough or taking out the dough. Above the opening section for placing the dough therein, a throat section is provided for taking out smoke and odor generated from inside the brick-oven. Smoke is then led to a tubular smoke exhaust section connected with the brick-oven body via a smoke exhaust area of the brick-oven body.

Upper portion of internal brick-oven body, there is a space for guiding heat and smoke generated from burning oven-wood, at a ceiling surface of this space, a heat conducting bar may be installed for keeping at a temperature uniformly suitable for baking dough.

Smoke and odor generated from the brick-oven is led into the smoke exhaust section of the brick-oven body, and emitted into the air through the tubular smoke exhaust section.

According to claim 1 of the present invention, the brick-oven having the smoke and odor removing filter is characterized by installing the catalyst action section in the smoke exhaust section of the brick-oven. At the catalyst action section, smoke and odor are burnt by the action of the catalyst so that the amount of smoke and odor generated from the brick-oven is reduced.

As a catalyst used for the catalyst action section there is no limitation if there is a catalytic role but it is preferred to select a catalyst from the group consisting of noble metals such as platinum (Pt), palladium (Pd), and rhodium (Rd), among them, platinum is particularly preferred. Catalysts exemplified here are particularly effective for imperfect combustion matters included in smoke by oxidative decomposition. In this oxidative decomposition, for example, organic compound is decomposed by having the imperfect combustion matters in contact with the catalyst at the temperature higher than 350° C.

The form of catalyst is not particularly limited to but it is preferred to have a larger contact area for contacting with smoke and odor. For example, it is preferred to have a supporting member having honeycomb structure in a round or a polygonal shape.

According to claim 2 of the present invention, the brick-oven having the smoke and odor removing filter is characterized by installing the heater in the vicinity of catalyst layer of the catalyst action section.

The action of the catalyst used in the present invention has an optimum temperature range. A heater is therefore installed in the vicinity of the catalyst layer so that the catalyst is kept at an optimum temperature (360° C.) for effective catalytic role for reducing smoke and odor further.

Accordingly, when a temperature of smoke running through the smoke exhaust section lowers and the catalytic role by the catalyst is lowered, the heater is heated up for keeping the optimum temperature to prevent the catalytic role from lowering, smoke and odor can be thus reduced.

According to claim 3 of the present invention, the brick-oven having the smoke and odor removing filter is characterized by installing the smoke and odor removing filter at least at the mouth of the smoke exhaust section of the brick-oven body, or at the tubular smoke exhaust section as defined by any one of claims 1 and 2.

The smoke and odor removing filter used in the present invention can be installed anywhere in the smoke exhaust section, however, it is preferred to install at least at the mouth of the smoke exhaust section of the brick-oven body or at the inlet area of the tubular smoke exhaust section whereby catalyst temperature once increased for reprocessing cannot be lowered so that electric power can be saved.

When the smoke and odor removing filter is installed in the vicinity of the mouth of the smoke exhaust section of the brick-oven, the temperature of smoke is high due to its installation close to the brick-oven body. Therefore catalytic role is strong enough for resulting in a large smoke and odor removing effect, even if heating by the heater in the vicinity of the catalyst section is small

The smoke and odor removing filter can be installed any place in the smoke exhaust section of the brick-oven. In addition, any number of the filters can be installed, it is preferred to install at least at the mouth of the smoke exhaust section, or between the inlet of the tubular smoke exhaust section and the middle section thereof. Heating by the heater is required if the filter is installed at an exhaust close to the open air because temperature is lowered.

According to claim 4 of the present invention, the brick-oven having the smoke and odor removing filter is characterized by the structure having the smoke and odor removing filter, and the air-intake blower fan, or air-outlet blower fan in the tubular smoke exhaust section of the brick-oven.

By installing the air-intake blower fan, or air-outlet blower fan in the tubular smoke exhaust section of the brick-oven, flow of smoke in the smoke exhaust section is expedited, by the installation of the blower fan, the size of smoke and odor removing filter can be made smaller, and a larger volume of smoke and odor can be processed so that the efficiency of smoke and odor removal can be improved.

According to claim 5 of the present invention, the brick-oven having the smoke and odor removing filter is characterized by the structure having the catalyst section including the catalyst layer, heating plate, and the heater as defined by any one of claims 1 through 4. By using the heater together with the heating plate, the heater can generate heating uniformly.

If smoke and odor can be removed by the catalyst, the smoke and odor removing filter is not particularly limited to, however, it is preferred to have the structure including the catalyst layer, heating plate, and the heater. It is preferred to have the structure of the filter, which is layered in the order of the heater, the heating plate, and the catalyst layer, in the smoke stream of upper stream to the lower stream. By this structure, the efficiency of smoke and odor removing efficiency can be improved. By the structure having this structural order, smoke is sufficiently heated by the heater and the heating plate, the heated smoke can be delivered to the catalyst layer thereby making the catalyst action time shorter.

According to claim 6 of the present invention, the brick-oven having the smoke and odor removing filter is characterized by the smoke and odor removing filter having multiple layers, each layer having the catalyst layer, the heating plate, and the heater as defined by any one of claims 1 through 5. It is preferred to have the structure of multiple layers of the catalyst action section of the smoke and odor removing filter. It is further preferred to have the catalyst action section of the smoke and odor removing filter, each having the structure of the catalyst layer, heating plate, and the heater. By this structure, smoke and odor can be removed efficiently.

It is further preferred to have each catalyst action section of the smoke and odor removing section having multiple layers, each layer having the catalyst layer 53, the heating plate 52 and the heater 51. By this structure, smoke and odor removing efficiency can be improved. Smoke and odor removing efficiency can be improved as the layers increase; however, an optimum number of layers can be selected in terms of manufacturing cost.

As a form of the catalyst layer 53 of the catalyst action section, a larger contact surface area against smoke and odor is desired while its structure is fit in an installation cross-section of the tubular smoke exhaust section. It is preferred as FIG. 4A shows a honeycomb supporting structure holds the catalyst layer in a round shape with a plurality of air ventilating holes.

As a heating plate 52, smoke and odor gas should pass therethrough without resistance and fits in the cross-section of the smoke exhaust section 54 for installation, a plate member for uniformly conducting heat generated by the heater for keeping the temperature of the catalyst layer. For example, it is preferred to have a disk shape having a plurality of holes for air ventilation as shown in FIG. 4B, which is made of a punched out metal plate.

As a heater 51, it should heat the catalyst layer uniformly against the cross-section perpendicular to the flow of smoke flow direction, for example, it is preferred as FIG. 4C shows, a pipe heater having a shape as shown in this figure may be used. As other alternatives, a ceramic heater, or halogen lamp heater etc. may be used.

According to the brick-oven having the smoke and odor removing filter, smoke and odor generated by incomplete combustion may be completely burnt by the smoke and odor removing filter thereby reducing smoke and odor therefrom. By installing the heater on the catalyst action section, catalyst action can be kept at an optimum temperature range; in addition, a high catalyst action can be obtained even if the temperature of smoke is dropped from an effective processing temperature for reducing smoke and odor.

### By adding multiple number of the catalyst action sections at the smoke exhaust intake area, and a plurality of the smoke and odor removing filters, smoke and odor to be emitted can be further reduced.

### BRIEF DESCRIPTION OF THE DRAWINGS

FIG. 1 is a partial sectional view showing an embodiment of a brick-oven system according to the present invention.

FIG. 2 is a schematic view showing flow of smoke in a conventional brick-oven system.

FIG. 3 is a sectional view showing an example of a structure of smoke and odor removing filter according to the present invention.

FIG. 4A, FIG. 4B and FIG. 4C are exploded views showing a smoke and odor removing filter according to the present invention.

FIG. 4A is a perspective view showing a catalyst block layer.

FIG. 4B is a plan view showing a heating plate.

FIG. 4C is a plan view showing a heater.

FIG. 5 is a sectional view showing a test equipment for testing efficiency of the smoke and odor removing filter according to the present invention.

FIG. 6 is a table showing a test result of the catalyst layer according to the smoke and odor removing filter of the present invention.

FIG. 7 is a table showing a test result of the catalyst layer according to the smoke and odor removing filter of the present invention.

FIG. 8 is a sectional view showing another example of a test equipment for measuring efficiency of the smoke and odor removing filter according to the present invention.

FIG. 9 is a graph showing temperature/time transition of smoke removing efficiency using another example of the test equipment.

FIG. 10 is a graph showing temperature/time transition of smoke removing efficiency using another example of the test equipment.

FIG. 11 is a sectional view showing a conventional brick-oven.

### A PREFERRED EMBODIMENT OF THE INVENTION

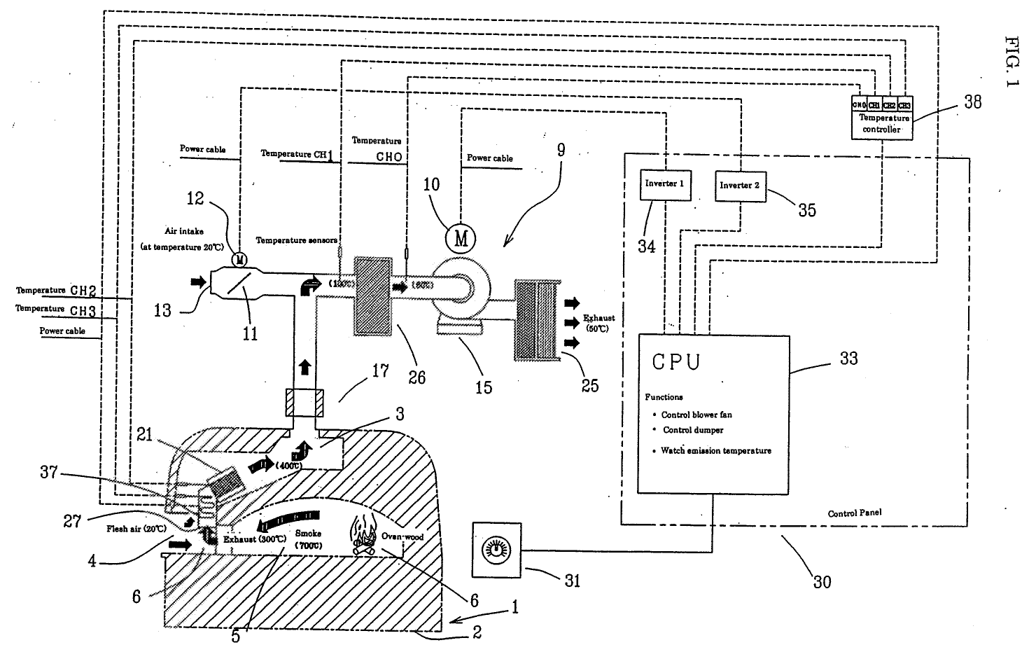

An embodiment of the present invention is now described hereunder referring to the drawings. FIG. 1 is a sectional view showing an embodiment of a brick-oven. In this figure, a brick-oven 1 has a structure including a brick-oven body 2, a smoke outlet area 3, and a tubular smoke exhaust section 9, as key structural sections. The brick-oven body 2 has an opening 4 having a door, if necessary, a dough placing area 5, an oven-wood burning area 6. The tubular smoke exhaust section 9 is a duct made of a metal, which is connected by a flexible pipe with the smoke exhaust area 3 of the brick-oven body

In the tubular smoke exhaust section 9, an external air intake fan 12 having an air flow adjustment dumper 11, an external air intake opening 13, and a heat resisting blower fan 15 for ventilation. It is preferred to install the smoke and odor removing filters (17, 21) at two locations in the vicinity of the smoke exhaust intake throat area of the brick-oven body 2 and the inlet area 17 of the tubular smoke exhaust section 9.

Both the smoke and odor removing filters 17 and the smoke and odor removing filter 21 have a similar structure.

However, the smoke and odor removing filter 21 installed near the smoke exhaust intake throat area of the brick-oven body 2, the heater may not be installed, because the temperature of smoke right out of the brick-oven is sufficiently high for the catalyst action without losing heat so that the heater may not be required. It is preferred to provide an air intake opening 27 for taking air therein thereby making smoke flow smooth and higher smoke and odor removing efficiency.

A control panel 30 has a CPU 33, inverters 34, 35 are installed for controlling the blower fan driving condition and the opening of the dumper 11, and watching the temperature of emitting smoke. The CPU 33 is connected with an exhaust smoke flow manual adjustment equipment 31 and temperature adjustment controllers 38.

The dough placing area 5 is provided in the internal brick-oven body 2 of the brick-oven 1 in addition to oven-wood burning area 6. At the upper portion of the brick-oven, the throat area 27 for taking smoke therein and the smoke and odor removing filter 21 is installed. By this structure, air for combustion (approximately 20° C.) taking from the opening area 4 becomes a heated exhaust smoke (approximately 700° C.) heated at the fuel combustion area 6 so that the dough is baked therein and then exhaust smoke (approximately 300° C.) flows into the smoke and odor removing filter 21 from the intake mouth 27.

The exhaust smoke (approximately 400° C.) passed through the smoke and odor removing filter 21 is then pass through the smoke and odor removing filter 17 (approximately 100° C.) by the suction power of the blower fan 15. The smoke is then goes through a filter 26 for removing fine soot and smoke (approximately 60° C.) and a filter 25 for removing last odor removal for emission. The smoke exhaust area 3 of the brick-oven body 2 and the tubular smoke exhaust section 9 are connected with the flexible pipe.

An air intake opening 13 is provided at the other end of the tubular smoke exhaust section 9, the air flow adjustment dumper 11 is provided in the vicinity of the air intake opening 13. The dumper for adjusting air flow is moved by a motor 12 for controlling the volume of suction air into the tubular smoke exhaust section 9. The air flow adjustment dumper 11 is adjusted by the smoke exhaust manual adjustment equipment 31.

Four temperatures measured are delivered through lines for detected temperatures (CH0, CH1, CH2, CH3) connected with the temperature controller section 38, and connected with the CPU 33 are processed as signals. While revolution of the blower fan 12 is controlled by the inverter 35 for taking air thereinto, revolution of a motor 10 of the blower fan 15 is controlled by an inverter 34.

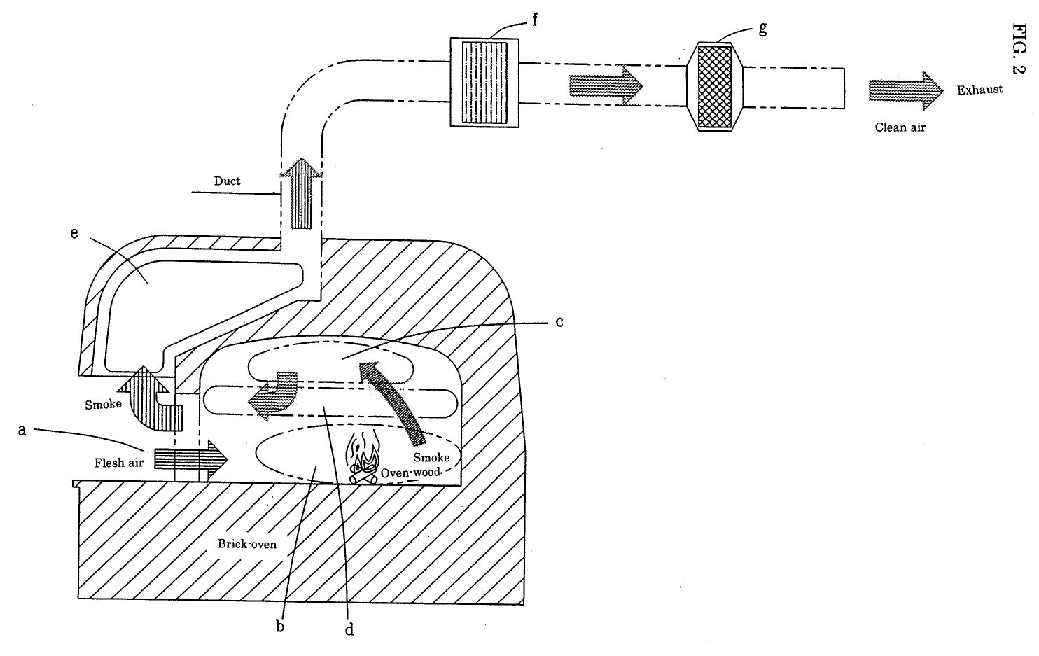

FIG. 2 is a schematic view showing a conventional flow of smoke in the brick-oven as an example of a system. In this figure, the smoke exhaust is treated by the following 7 steps of (a) through (g):

### Reference symbol (a) in FIG. 2 is a region where flesh air is taken into the oven to expedite oven-wood burning

### Reference symbol (b) is a region for burning suitably by receiving a suitable volume of air from outside,

### Reference symbol (c) in FIG. 2 is a region for keeping heat generated by the burning firewood for reserving heat in the upper portion (where radiation heat is generated, and approximately 650° C. is the complete combustion temperature of the oven)

### Reference symbol (d) in FIG. 2 is an intermediate region where a smoke having a high carbon purity retention without complete combustion is staying (approximately 250° C. is the temperature of smoke, soot matters)

### Reference symbol (e) in FIG. 2 is a region for re-burning the smoke exhaust having incomplete combustion (first treatment)

### Reference symbol (f) in FIG. 2 is a filter treatment section for filtering incomplete combustion matters further (second treatment)

### Reference symbol (g) in FIG. 2 is a filter treatment section using an activated carbon for removing odor elements from heated smoke to be emitted.

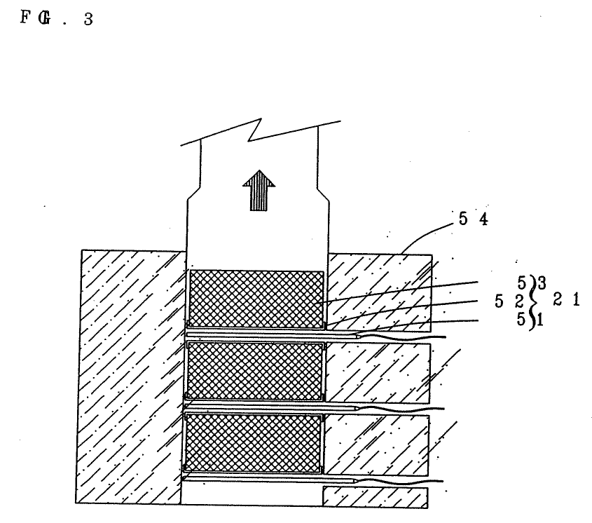

FIG. 3 is a sectional view showing the smoke and odor removing filter 21. The smoke and odor removing filter 21 has a structure including the heater 51, the heating plate 52 and the catalyst layer 53 as three components of the filter stacked from the upper stream to the lower stream in the direction of smoke flow. In this figure, three sets of filters, each having the three components are serially stacked.

It is preferred to keep temperature by using a thermal resistant material 54 around the catalyst action treatment area. According to the brick-oven of the present invention, the smoke and odor removing filter 21 installed near the smoke intake throat area of the brick-oven body 2 for removing smoke and odor when a large amount of smoke and odor are generated.

In the smoke outlet area 3 of the brick-oven 1, the temperature reaches to 350° C., which is high enough suitable for the catalyst action without installing the heater. If the smoke is not processed at this stage, the multiple heaters in the smoke and odor removing filters 17 installed in the upper stream apart from the blower fan 15 for smoke exhaust heats up the catalyst temperature higher at a suitable temperature.

The temperature passing through the smoke and odor removing filter 21 does not drop significantly because the temperature of the smoke is high enough from the brick-oven. Although, heating by the heater is not necessary at this location, the heater increases the catalyst action so that the efficiency of the smoke and odor removal can be increased.

By providing air intake openings both at the smoke and odor removing filter and in the vicinity of the tubular smoke exhaust section 9, smoke flows smoothly so that the efficiency of smoke and odor removal can be increased. It is further preferred to provide a fine smoke and soot removal filter 26 in the middle of the tubular smoke exhaust section 9, and the odor removal filter 25 is provided at the end of the tubular exhaust section 9, respectively, emission of smoke and odor cab be further reduced.

According to the brick-oven body 2 of the present invention, it is possible to provide reduced emission of smoke and odor depending on the condition of operation. Temperature can be controlled by controlling the flow of smoke by taking the air thereinto, and sensors or thermocouples installed at smoke emission area, and near the heaters, and by controlling electric power consumption used for the brick-oven body 2, economical and efficient smoke and odor emission can be performed, so that environmentally conscious emission of smoke can be emitted, thereby living environment can be improved. Watching operation can be displayed in the control panel 30 while the emission of smoke is set or adjusted using the exhaust flow volume manual adjustment equipment 31 on a real time basis.

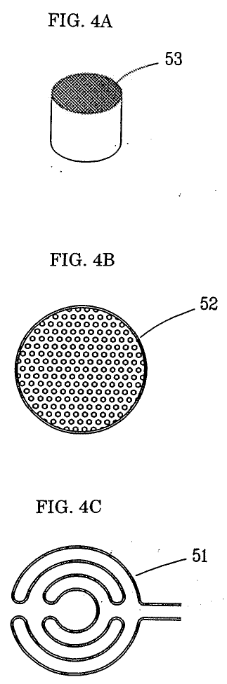

FIG. 4A is a perspective view showing an example of the catalyst layer 53 having honeycomb structure according to the present invention.

### FIG. 4B is a plan view showing the heating plate 52 used for the present invention.

### FIG. 4C is a plan view showing the heater 51.

Three components including the catalyst layer 53, the heating plate 52, and the heater 51 constitute the smoke and odor removing filter 21 in FIG. 3.

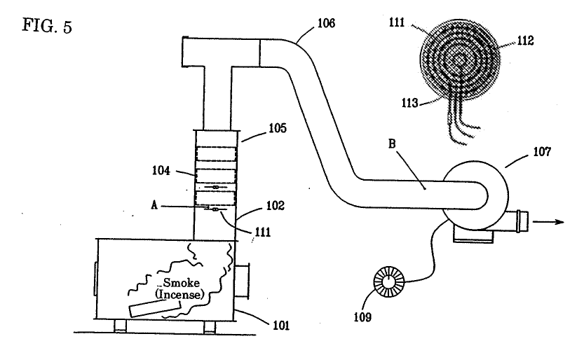

FIG. 5 is a sectional view showing a test equipment for testing catalyst performance. In this equipment, a duct 105 on an exhaust area 101 of an oven extends in upward direction and connected with a duct 106 extending to the right hand side. A fan 107 is installed at the end of the duct 106. This fan 107 is a fan having a filter function and the blower revolution controller 109 controls the revolution thereof by controlling the voltage using a variable voltage transformer.

In addition, the duct 105 includes an assembly 104 having a heater 111, a catalyst 112, and a thermocouple 114 in a case 102.

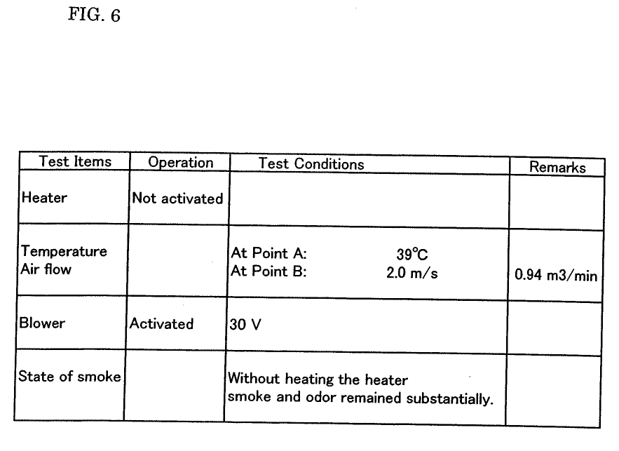

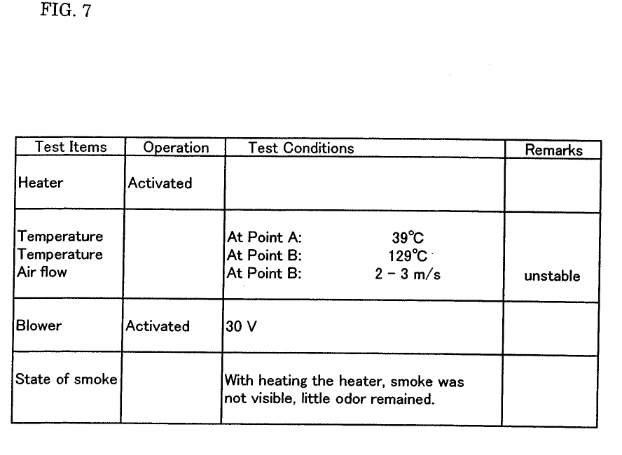

FIG. 6 is table showing a test result tested without activating the heater. FIG. 7 is a table showing a test result with activating the heater. As in FIG. 6, the temperature at the point A in FIG. 5 was about 39° C., and flow of the smoke at the point B in FIG. 5 was 2.0 m/s and smoke and odor remained substantially. As in FIG. 7, when the heater was activated, the temperature near the point A was 386° C., and at the point B was 129° C. and the flow of smoke was 2-3 m/s, smoke was not visible, however, little odor remained.

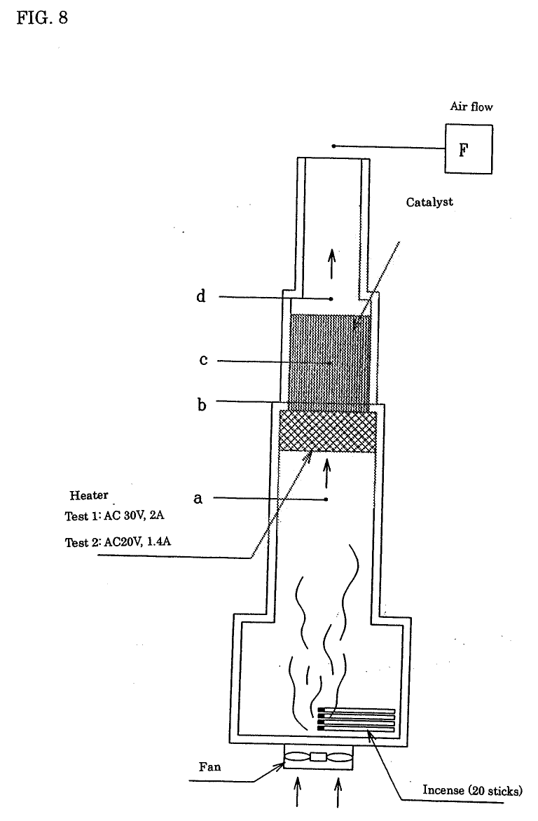

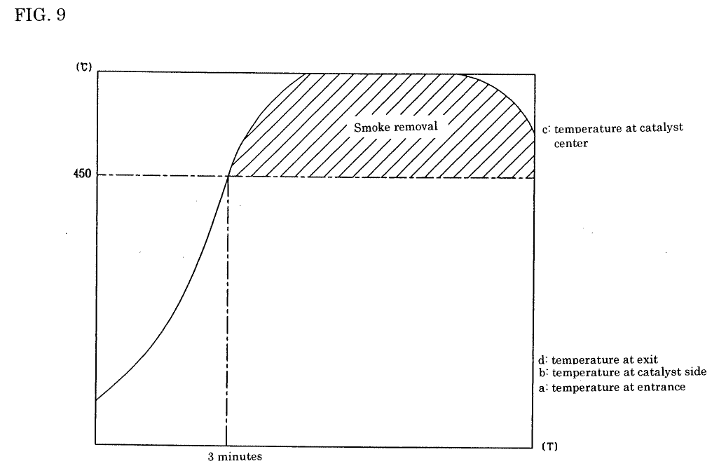

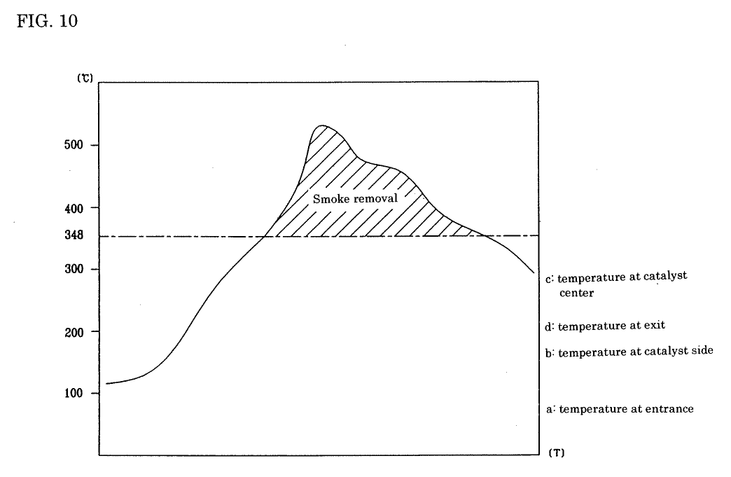

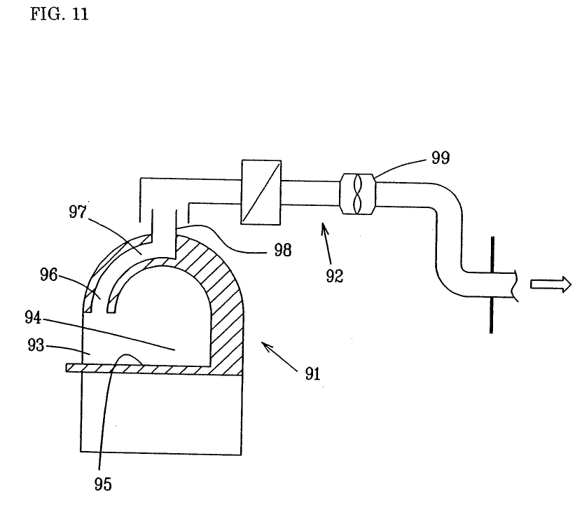

FIG. 8 is a sectional view showing a test equipment for measuring data of a catalyst by temperature. FIG. 9 and FIG. 10 are graphs showing temperature in the direction of the vertical axis, and temperature in the direction of the horizontal axis.

According to FIG. 9, Test 1 was performed by setting an air flow F at 0.05-0.1 m/s and the heater was supplied with a power of AC30V, 2 A. 3 minutes after the test had started, smoke was faded away, and moisture remained.

According to FIG. 10, Test 2 was performed by setting air flow F at 0.05-0.1 m/s, and the heater was supplied with AC 20V and 1.4V power, moisture had generated and smoke was remained at the temperature of 348° C. at point C in FIG. 8. However, when the temperature went up to 540° C., smoke was almost gone.

What is claimed is:

1. A brick oven comprising:
an oven body, and
a smoke and odor removing filter,
wherein said smoke and odor removing filter has a catalyst member at a smoke exhaust section.

2. A brick-oven as recited by claim 1, further comprising a heater in the vicinity of said catalyst layer of said smoke and odor removing filter.

3. A brick-oven as recited by claim 1, wherein at least said smoke and odor removing filter installed at a throat of said smoke exhaust section of said brick-oven, or in said smoke exhaust stack section.

4. A brick-oven as recited by claim 1, further comprising:
an air intake blower fan or an exhaust blower fan provided in said smoke exhaust stack section.

5. A brick-oven as recited by claim 1, further comprising:
said smoke and odor removing filter including said catalyst layer, a heating plate, and said heater.

6. A brick-oven as defined by claim 1, further comprising:
a plurality of said smoke and odor removing filters at a plurality of stages.

7. A brick-oven as recited by claim 2, wherein at least said smoke and odor removing filter installed at a throat of said smoke exhaust section of said brick-oven, or in said smoke exhaust stack section.

8. A brick-oven as recited by claim 2, further comprising:
an air intake blower fan or an exhaust blower fan provided in said smoke exhaust stack section.

9. A brick-oven as recited by claim 3, further comprising:
an air intake blower fan or an exhaust blower fan provided in said smoke exhaust stack section.

10. A brick-oven as recited by claim 2, further comprising:
said smoke and odor removing filter having said catalyst layer, a heating plate, and said heater.

11. A brick-oven as recited by claim 3, further comprising:
said smoke and odor removing filter having said catalyst layer, a heating plate, and said heater.

12. A brick-oven as recited by claim 4, further comprising:
said smoke and odor removing filter having said catalyst layer, a heating plate, and said heater.

13. A brick-oven as recited by claim 2, further comprising:
a plurality of said smoke and odor removing filters at a plurality of stages.

14. A brick-oven as recited by claim 3, further comprising:
a plurality of said smoke and odor removing filters at a plurality of stages.

15. A brick-oven as recited by claim 4, further comprising:
a plurality of said smoke and odor removing filters at a plurality of stages.
